(19) United States
(12) Patent Application Publication
(10) Pub. No.: US 2013/0153355 A1
(43) Pub. Date: Jun. 20, 2013

(54) HYDRAULIC CLUTCH ASSEMBLY

(71) Applicants: Martin Eugene Kummer, Auburn, IN (US); Mark Charles Barnholt, Fort Wayne, IN (US)

(72) Inventors: Martin Eugene Kummer, Auburn, IN (US); Mark Charles Barnholt, Fort Wayne, IN (US)

(73) Assignee: EATON CORPORATION, Cleveland, OH (US)

(21) Appl. No.: 13/327,868

(22) Filed: Dec. 16, 2011

(51) Int. Cl. F16D 13/72; F16D 13/52

(52) U.S. Cl. 192/48.1; 192/70.12; 192/113.31

(57) ABSTRACT

A wet clutch assembly has an inner housing configured for rotation with an input torque member to the clutch assembly. The inner housing has a series of splines to support a portion of the plates in a clutch pack. Each spline defines a single aperture in fluid communication with at least one plate of the clutch pack, and apertures on adjacent splines are offset to distribute cooling fluid nearly equally between friction surfaces. Uniform flow distribution ensures efficient use of cooling fluid and prevents overheating of plates receiving lesser fluid flow.

### TECHNICAL FIELD

Various embodiments of the disclosure relate to a hydraulic or wet clutch assembly having channels with ports in the inner hub of the clutch assembly for thermal management of the clutch assembly.

### BACKGROUND

Hydraulically actuated clutches, or wet clutches, use coolant flow for thermal management of the clutch plates as they generate heat from friction during operation of the clutch. In the past, thermal management of the wet clutch included increasing the coolant volumetric flow rate to the clutch to increase heat transfer away from the clutch plates. However, this may be inefficient and also result in poor cooling uniformity and thermal management of the plates in the clutch pack.

### SUMMARY

In one embodiment, a wet clutch assembly includes an inner housing supporting a series of splines. The splines rotate with an input torque member to the clutch assembly. An outer housing rotates with an output torque member from the clutch assembly. A clutch pack is interposed between the inner and outer housing. The clutch pack selectively transfers torque from the input member to the output member. The clutch pack has a series of plates supported by the splines. Each spline defines a single aperture in fluid communication with at least one plate of the clutch pack. Apertures on adjacent splines are offset.

In another embodiment, a dual clutch assembly is provided. A first clutch is configured to selectively transfer torque from an input torque member to a first output torque member of the clutch assembly. The first clutch has a first series of plates and a first series of cooling channels. Each cooling channel defines a single port that is in fluid communication with at least one plate. Ports on adjacent cooling channels are offset from one another. A second clutch is configured to selectively transfer torque from the input torque member to a second output torque member of the clutch assembly. The second clutch has a second series of plates and a second series of cooling channels. Each cooling channel defines a single port in fluid communication with at least one plate. Ports on adjacent cooling channels are offset from one another.

In yet another embodiment, an inner housing for a clutch is provided with a generally cylindrical housing formed about a longitudinal axis. A first series of cooling channels is supported by the housing and configured for flow along the longitudinal axis. Each cooling channel in the first series defines a single aperture on an outer surface of the housing at a first position along the axis. A second series of cooling channels is supported by the housing and configured for flow along the longitudinal axis. Each cooling channel in the second series defines a single aperture on the outer surface of the housing at a second position along the axis.

The above aspects of the disclosure and other aspects are described below with reference to the attached drawings.

### BRIEF DESCRIPTION OF THE DRAWINGS

FIG. 1 is a schematic of a transmission with a dual clutch assembly according to an embodiment;

FIG. 2 is a cross-sectional schematic of the dual clutch assembly of FIG. 1;

FIG. 3 is a perspective cross-sectional and cutaway view of the dual clutch assembly of FIG. 2;

FIG. 4 is a partial perspective view of an inner housing for a clutch assembly according to an embodiment;

FIG. 5 is a schematic of friction plates and faces for the clutch assembly of FIG. 4; and

FIG. 6 is a chart modeling axial flow for the clutch assembly of FIGS. 4 and 5.

### DETAILED DESCRIPTION

A detailed description of the illustrated embodiments of the present invention is provided below. The disclosed embodiments are examples of the invention that may be embodied in various and alternative forms. The figures are not necessarily to scale. Some features may be exaggerated or minimized to show details of particular components. The specific structural and functional details disclosed in this application are not to be interpreted as limiting, but merely as a representative basis for teaching one skilled in the art how to practice the invention.

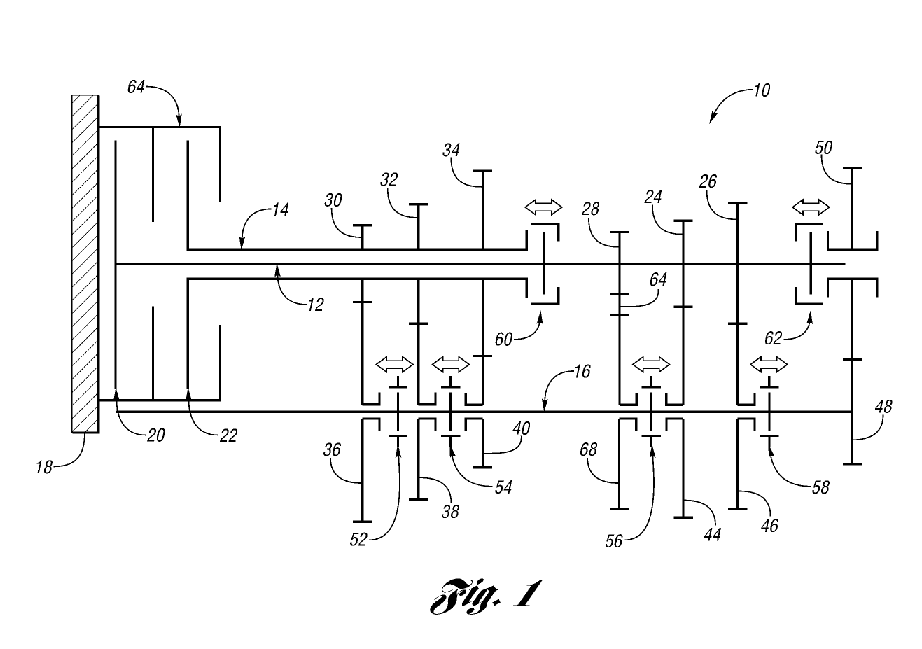

In FIG. 1, transmission 10 includes a first input shaft 12, a second input shaft 14, a countershaft 16 that extends substantially parallel with first and second input shafts 12 and 14, and gears which are arranged on and/or around shafts 12, 14, and 16.

The first input shaft 12 is in communication with an output member 18, such as a flywheel, of an engine or other prime mover through a first main clutch 20 and a second main clutch 22. In one embodiment, the first main clutch 20 is used to establish even speed gearing (second, fourth, and reverse gearing) through input shaft 12. The second input shaft 42 may be connected to flywheel 18 using the second main clutch 22 to establish odd speed gearing (first, third, and fifth).

The hydraulically actuated clutches 20, 22, or wet clutch, is shown in a dual clutch arrangement in a transmission 10 for use in a powertrain system. Alternatively, the clutch 20 may be used in other types of torque transmission arrangements as are known in the art including small, medium, and heavy duty powertrain systems. The hydraulically actuated clutch 20 has improved thermal management of the plates in the clutch pack by controlling the coolant flow path that provides for use in high thermal event connections. For example, a high thermal event may include a dual clutch system with both clutches 20, 22 slipping, such as when one clutch is engaging while the other is disengaging. The use of the clutches 20, 22 in a dual clutch transmission is provided for illustrative purposes, and should not be viewed as limiting the disclosure.

In some embodiments, the first and second main clutches 20, 22 are of a normally “on” type, with the on or engaged state caused by a spring biasing force, or the like, under a normal condition, and with the off or disengaged state caused by a command to engage a hydraulic or electric actuator. Engagement and disengagement of first and second main clutches 20, 22 may function automatically under the control of a vehicle system controller (VSC), and without the intervention of a user driver, such that the transmission 10 operates as an “automatic” transmission.

Even speed gearing, such as second speed input gear 24, fourth speed input gear 26 and reverse input gear 28, are connected to the first input shaft 12 such that they rotate with the shaft 12. Similarly, odd speed gearing, such as a first speed input gear 30, third speed input gear 32, and fifth speed input gear 34, are connected to the second input shaft 14 such that they rotate with the shaft 14. The number of gears and arrangement of the gears as shown on the first and second input shafts 12, 14 is not limited to the illustration of FIG. 1. The term “gear” may be used to define either a toothed wheel or toothed features directly manufactured into a shaft.

Output gearing is connected to countershaft 16 to selectively engage the input gearing as described above. A first speed output gear 36, third speed output gear 38, fifth speed output gear 40, reverse output gear 42, second speed output gear 44, and fourth speed output gear 46 are connected to countershaft 16 to rotate with the countershaft 16. The number of output gears provided on countershaft 16 is not limited in number or arrangement, and may vary with the number and arrangement of input gears.

A final drive pinion gear 48 is also connected to the countershaft 16 to rotate with the countershaft 16. The final drive pinion 18 is meshed with a rotational output member 50, such as a final drive ring gear. For example, transmission 10 output rotation from drive pinion 48 to output member 50 may be distributed to vehicle wheels through a drive shaft and a differential.

The transmission 10 has axially moveable clutches 52, 54, 56, and 58, such as synchronized single or double acting dog-type clutches, that are splined to countershaft 16 to rotate with the countershaft. The clutches 52, 54, 56, 58 may be moved in an axial direction to fix one of the output gears to the countershaft 16 for rotation with the countershaft. In another embodiment, the clutches 52, 54, 56, 58 may be provided on the first and second input shafts 12, 14 to engage and disengage gears on the input shafts 12, 14 for rotation with the input shafts.

The transmission 10 also includes axially moveable input shaft clutches 60 and 62, such as synchronized single acting dog-type clutches, that are splined to the first input shaft 12 to rotate with the shaft 12. The clutch 60 may be moved in an axial direction with respect to the main clutch assembly 64 to fix first input shaft 12 for rotation with second input shaft 14. Similarly, clutch 62 may be moved in an axial direction to fix the first input shaft 12 for rotation with output member 50.

For example, during vehicle launch and acceleration, the first and second main clutches 20, 22 are initially disengaged and clutch 52 is moved to fix the first speed output gear 36 to countershaft 16. When the clutch 52 is engaged, power or torque from a prime mover and input 46 may be transmitted to countershaft 16 by engaging the second main clutch 22. The power applied to second input shaft 14 is transmitted from the flywheel 46 through the second clutch 22 to the second shaft 14. Power is then transmitted through the first speed input gear 58 on the second shaft 14 to the first speed output gear 36 on the countershaft 16. The output gear 36 transmits power to the final drive pinion 48 and rotational output member 50 so that a first speed ratio is established in transmission 10.

As the vehicle accelerates and a second speed ratio is desired, clutch 56 is engaged while the first main clutch 20 is disengaged, such that the second speed output gear 44 is fixed to countershaft 16 and no power is being transmitted from flywheel 46 to the first input shaft 12 at this point. The currently engaged second main clutch 22 is disengaged after the clutch 56 is engaged, while simultaneously or nearly simultaneously engaging the first main clutch 20. This causes the power to change paths from the second input shaft 14 to the first input shaft 12, with a corresponding change in gearing ratio. Power applied to the first input shaft 12 is transmitted through the second speed input gear 24 to countershaft 16 through second speed output gear 44, and then to the final drive pinion 48 and rotational output member 50 to establish a second speed ratio in the transmission 10. This process may be repeated, with the selective activation of the appropriate clutch, in the same manner for up-shifting through the remaining gear ratios, in a reverse manner for down-shifting from one gear ratio to another, or for shifting into reverse gear using an idler gear 63.

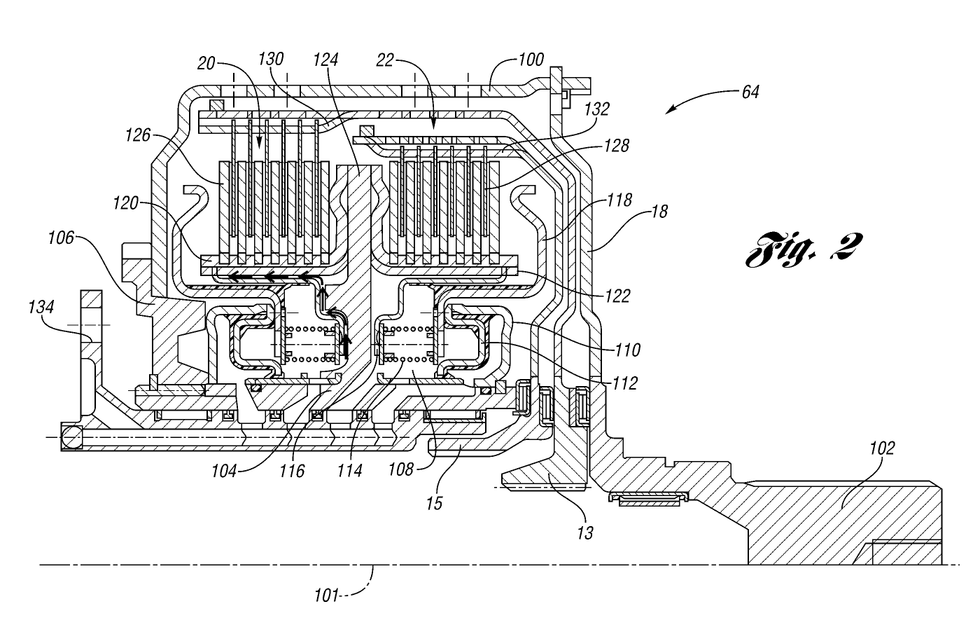

FIGS. 2 and 3 illustrate embodiments of a hydraulically actuated clutch that may be used as a main clutch 20, 22 of FIG. 1.

The main clutch assembly 64 has an input housing 100, connected to and rotating with the output member 18. The output member 18 is connected to and rotates with an input hub 102 that is rotated by the prime mover or engine about rotational axis 101. The input housing 100 is connected to a main hub 104 that may operate as a rotating manifold to direct coolant fluids to the clutches 20, 22.

The main hub 104 supports a pump drive gear 106 and a pair of hydraulic piston systems 108. The hydraulic piston systems 108 each include a piston housing 110, an apply piston 112, a spring pack 114, an oil guide 116, and a balancing piston 118. The hydraulic piston systems 108 may or may not be symmetrical based on the desired sizing of the clutches and the packaging requirements for the clutch assembly 64. The hydraulic piston systems 108 are shown as opposed pistons, although other configurations may also be used.

The main hub 104 and input housing 100 also support an inner housing 120 for the first clutch 20 and an inner housing 122 for the second clutch 22. The inner housings 120, 122 are additionally supported by a support disk 124 extending from the main hub 104. In the embodiment shown, a series of separator plates 126, or reaction plates, for each clutch 20, 22 are supported by the inner housings 120, 122, such that the separator plates 126 rotate with the main hub 104. Each inner housing 120, 122 has channels and ports formed into it to direct coolant between the separator plates 126.

The clutches 20, 22 also each have a series of friction plates or disks 128 that are interposed or interleaved between the separator or clutch plates 126. The friction plates 128 for the first clutch 20 are supported by a first outer housing 130. The friction plates 128 for the second clutch 22 are supported by a second outer housing 132. The friction plates 128 may have grooves, such as a pattern of waffle grooves, or other patterns on the surface to move coolant fluid. Together, the separation plates 126 and friction plates 128 form a clutch pack.

The friction plates 128 move with respect to the separator plates 126 of the first clutch 20 when the clutch 20 is disengaged or slipping. The first outer housing 130 rotates with a mating spline 13 that is connected to the first shaft 12. The rotating hub 104 transfers rotation and power through an engaged clutch 20 and to the outer housing 130, mating spline 13, and first shaft 12. When the clutch 20 is engaged, the friction plates 128 and the separator plates 126 of the first clutch are stationary and locked with respect to one another, or may be slipping such that the plates 126, 128 are moving with respect to one another under friction.

The friction plates 128 move with respect to the separator plates 126 of the second clutch 22 when the clutch is disengaged or slipping. The second outer housing 132 rotates with a mating spline 15 that is connected to the second shaft 14. The rotating hub 104 transfers rotation and power through an engaged clutch 22 and to the outer housing 132, the mating spline 15, and second shaft 14. When the clutch 22 is engaged, the friction plates 128 and the separator plates 126 of the second clutch are stationary and locked with respect to one another, or may be slipping such that the plates 126, 128 are moving with respect to one another under friction.

The support manifold 134 supplies fluid to main hub 104 that supplies fluid to the first and second clutch 20, 22 through ports in the main hub 104. As the main hub 104 rotates, fluid contained in the main hub 104 tends to rotate and will be accelerated away from the axis 101. High-pressure circuits control piston movement while low-pressure circuits provide fluid for clutch cooling. The high-pressure fluid biases the respective pistons 112 and acts against the biasing force of springs 114. Additionally, the low-pressure fluid fills the chambers adjacent to balancing pistons 118. Low-pressure fluid for cooling flows under the spring seat of the oil guide 116 and then flows axially between the oil guide 116 and the spines of the inner housing 120, 122 until reaching port 136 shown in FIG. 3. Low-pressure fluid also flows, as shown by arrows in FIG. 3, through ports 136 in the first and second inner housing 120, 122 to cool frictional surfaces between the separation and friction plates 126, 128 of the first and second clutches 20, 22.

The contacting frictional surfaces of various friction plates 126, 128 in each clutch 20, 22 may reach different temperatures during operation if not cooled adequately and uniformly. When the distribution of fluid through the clutch pack is not uniform, the friction plates receiving the least fluid may be vulnerable to overheating and wear. Prior art designs may result in low flow (or non-uniform flow) to the farthest plates 128 in a clutch, and may require increasing the volumetric flow rates to adequately cool the clutch, Alternatively, non-uniform flow in the prior art may result in overheating some of the plates within the clutch during higher thermal events even with increased volumetric flow rates.

The efficiency of the clutch or efficiency of the cooling process decreases if the temperatures vary between frictional disks within a clutch pack. The frictional disk may degrade and the clutch performance may decrease if the thermal load and temperature on a frictional disk is too high over time. The thermal management of the frictional disks in a clutch may be determined. Modeling, such as computational fluid dynamics, may be used to model and estimate whether the clutch plates are being adequately cooled by the coolant. Testing, such as through high duty cycles on the clutch, may be used to verify the modeling results and for additional data. Various embodiments use inner housings 120, 122 with cooling ports strategically positioned to more evenly distribute flow to the frictional plates 128 and reduce the amount of temperature variation between clutch plates. The size of the coolant pump for the manifold 134 may be reduced after the amount of temperature variation between clutch plates is reduced, also leading to higher efficiencies.

FIG. 3 illustrates a variation of the clutch assembly 64 with the piston assemblies 108 acting in the same direction as one another, although the piston assemblies may also be opposed or otherwise arranged with respect to one another. As shown in FIG. 3, the ports 136 are offset from one another and are located on splines 138 of the inner housing 120. The frictional plates 128 and most of the separator plates 126 removed from the view to illustrate the inner housing 120. The splines 138 serve to position the separator plates 126 and also act as channels for the coolant to flow through. The coolant flowing through each spline 138 is shown by a dashed line. Only a single coolant port or aperture 136 is placed into an individual spline in order to direct coolant to designated plates with the clutch pack. Flow uniformity to the later plates is improved and temperature can be better regulated by having a single port 136 in each spline 138.

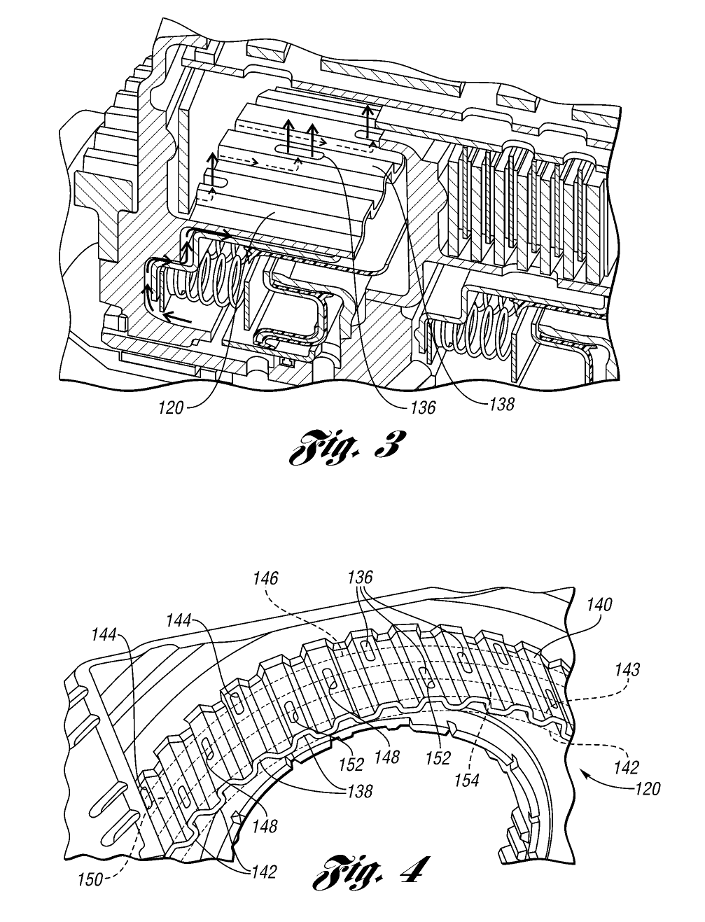

An embodiment of the inner housing 120 is illustrated in FIG. 4, and the description of the inner housing 120 as follows also applies to the inner housing 122. The inner housing 120 has a cylindrical housing 140 with a first inner diameter having inner wall sections 142. The splines 138 extend outward from the inner wall sections 142 to a second outer diameter 143 of the inner housing 120 and are radially positioned about the cylindrical housing 140. A cross section of the wall sections 142 and splines 138 resembles a corrugated pattern. The splines 138 are designed to retain a separator plate 126 having a corresponding pattern that meshes with the cylindrical housing 140 so that the separator plates 126 rotate with the inner housing 120.

Each spline 138 has a port 136 positioned at an axial location along the length of the spline 138. The number of ports 136 may vary depending on the number of plates in the clutch pack that are used with the inner housing 120. In the embodiment shown, there are three axial positions for the ports 136. The inner housing 120 supports six separator plates and six friction plates such that any given port supplies coolant to the two friction plates it is adjacent to. The ports 136 are elongated in shape or cross section, and may be a rounded rectangle, an ellipse, or the like. Of course, the ports 136 may be shaped differently to provide coolant to greater or fewer plates, and may be circular, polygonal, complex polygonal, or other shape as is known in the art. The ports 136 may have equivalent cross-sections to one another for the coolant to pass through. Of course, in other embodiments, the area of the ports may vary compared to one another.

In the embodiment shown, a first series of ports 144 are positioned at a first axial position 146 of the inner housing 120. A second series of ports 148 are positioned at a second axial position 150 of the inner housing 120. A third series of ports 152 are positioned at a third axial position 154 of the inner housing 120. The axial positions 146, 150, 154 are offset by an equidistant amount, however, other amounts of offset are also contemplated.

Each series of ports may have the same number of ports, or a different number. For example, each series of ports may have nine ports, twelve ports, or any other number. Flow is radially distributed to the plates by providing coolant to the plates from multiple ports in the series arranged around the circumference of the inner housing.

The ports in each series are sequentially positioned radially about the inner housing. For example, on three consecutive splines 138 there is a port from the first, second and third series of ports 144, 148, 152, as shown. The pattern repeats itself about the circumference of the inner housing 120. In other embodiments, other positioning arrangements may be used for the ports 138.

The inner surface of each spline 138 forms a channel for coolant flow. Coolant flows along the interior surface of the spline 138 until reaching the port 136 on the spline 138. Coolant flows through the port 136 and to the clutch pack. Coolant flows by centrifugal forces along the channel as the inner housing 120 rotates with the clutch hub 104.

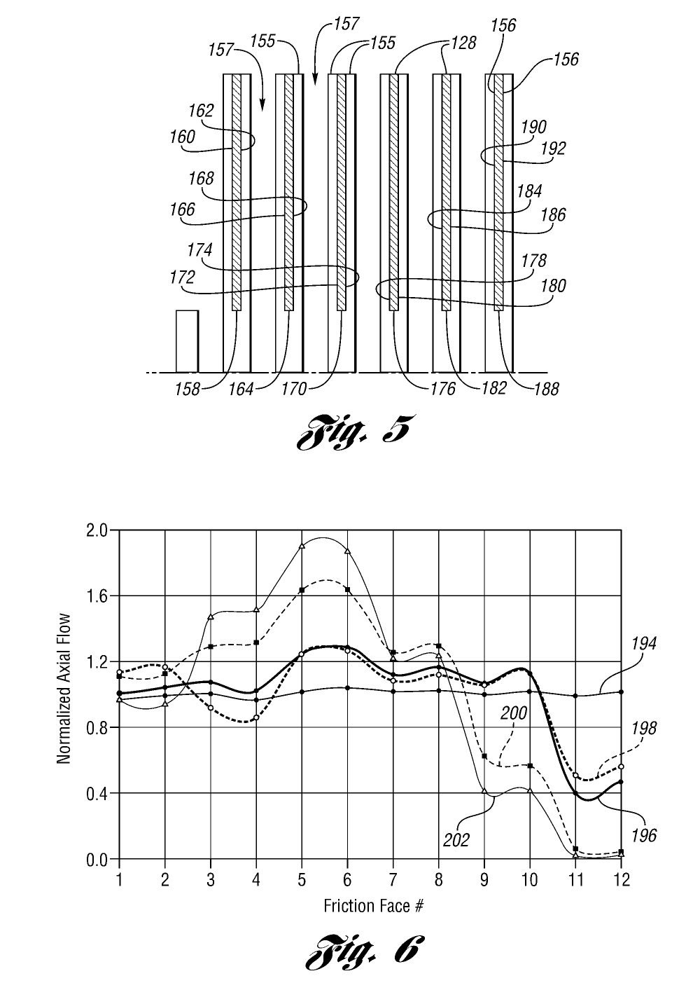

FIG. 5 illustrates the fluid pathways 155, including grooves in the friction material, of a clutch 20 having six friction plates 128. Each plate 128 has a pair of faces 156, such that there are twelve faces in the clutch pack as shown. A series of separator plates 126 are located as shown by arrows 157. The first friction plate 158 has faces 160, 162. The second plate 164 has faces 166, 168. The third plate 170 has faces 172, 174. The fourth plate 176 has faces 178, 180. The fifth plate 182 has faces 184, 186. The sixth plate 188 has faces 190, 192.

The ports in the inner housing are positioned and offset such that the first series of ports 144 provides coolant to the first and second plates 158, 164. The second series of ports 148 provides coolant to the third and fourth plates 170, 176. The third series of ports 152 provides coolant to the fifth and sixth plates 182, 188. For example, the third series of ports 152 provide a dedicated flow path for coolant to the fifth and sixth plates 182, 188. The coolant flowing through the splines 138 defining the third series of ports 152 may only flow to the fifth and sixth plates 182, 188 thereby increasing flow uniformity to the plates and improved thermal management. In the embodiment shown, each pair of plates receives approximately a third of the coolant flowing through the main clutch 20. The number of ports for the example shown has the number of series of ports, or axial positions for the ports, equal to half of the total number of friction plates. In other embodiments, the main clutch 20 may have greater or fewer plates, greater or fewer axial port positions, and differing ratio of plates to axial positions.

FIG. 6 illustrates computational modeling results for axial coolant flow through the clutch and port configuration as described with respect to FIG. 5. The chart plots normalized axial flow through the clutch versus the friction face. The clutch is in an open position, such that the output speed of the clutch is zero. The chart plots axial flow for various input speeds. Line 194 represents a lower input speed to the clutch, such as 800 revolutions per minute, and the axial flow is fairly uniform to all of the clutch plates. Line 196 represents a moderate input speed to the clutch, such as 1200 revolutions per minute, and the axial flow varies somewhat with significant axial flow to all of the clutch plates. Line 198 represents a higher input speed to the clutch, such as 1600 revolutions per minute, and the axial flow also varies somewhat with significant axial flow to all of the clutch plates.

In prior art systems, with more than one port on a spline, the normalized axial flow to the fifth and sixth plates 182, 188 may fall near zero as the coolant exits the channel through an earlier port, leading to non-uniform flow and varying temperatures in the plates in a clutch undergoing high thermal events.

An example of a prior art system having three axial port locations with the first and third axially positioned ports on the same spline, and the second axially positioned port on a different spline is also displayed on FIG. 6 for reference with the same clutch conditions. A low clutch input speed for the prior art design is similar to that shown by line 194. A moderate clutch input speed of 1200 rpm is illustrated by line 200, and the flow becomes non-uniform with high flow to the middle plates and low flow to the later plates. A higher input speed of 1600 rpm is illustrated by line 202, and the flow continues to be non-uniform with higher flow to the middle plates, and lower flow to the later plates.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments that are not explicitly illustrated or described.

One or more embodiments have been described as providing advantages or being preferred over other embodiments and/or over prior art with respect to one or more desired characteristics. As such, any embodiments described as being less desirable relative to other embodiments with respect to one or more characteristics are not outside the scope of the claimed subject matter.

What is claimed is:

1. A wet clutch assembly comprising:
an inner housing supporting a series of splines, the inner housing configured for rotation with an input torque member to the clutch assembly;
an outer housing configured for rotation with an output torque member from the clutch assembly; and
a clutch pack interposed between the inner and outer housing for selectively transferring torque from the input member to the output member, the clutch pack having a series of plates, a portion of the plates supported by the splines;
wherein each spline defines a single aperture in fluid communication with at least one plate of the clutch pack; and
wherein the aperture on each splines is offset relative to apertures on adjacent splines.

2. The clutch assembly of claim 1 wherein each spline is configured to act as a channel for flow of a coolant through the aperture and to the clutch pack.

3. The clutch assembly of claim 1 wherein each aperture is in fluid communication with designated clutch plates for thermal management of the designated clutch plates.

4. The clutch assembly of claim 1 wherein each aperture is elongated to provide coolant to more than one plate.

5. The clutch assembly of claim 1 wherein the aperture on each spline is positioned at one of three axial positions.

6. The clutch assembly of claim 1 wherein the inner housing is configured such that rotation of the input torque member drives flow through the apertures by centrifugal force.

7. The clutch assembly of claim 1 wherein each plate in the clutch pack is in fluid communication with an equal number of apertures.

8. The clutch assembly of claim 1 wherein the other portion of plates is supported by the outer housing.

9. The clutch assembly of claim 1 wherein each aperture has the same cross sectional area.

10. The clutch assembly of claim 1 wherein the inner housing is generally cylindrical about a rotational axis, the outer diameter of the inner housing engaged with the inner diameter of the portion of clutch plates, the apertures offset to one of a plurality of positions along the rotational axis.

11. The clutch assembly of claim 1 wherein the number of axial positions of apertures in the inner housing equals half of the portion of the clutch plates.

12. A dual clutch assembly comprising:
a first clutch configured to selectively transfer torque from an input torque member of the clutch assembly to a first output torque member of the clutch assembly, the clutch having a first series of plates and a first series of cooling channels, each cooling channel defining a single port in fluid communication with at least one plate, wherein the port on each cooling channel is offset relative to ports on adjacent cooling channels; and
a second clutch configured to selectively transfer torque from the input torque member of the clutch assembly to a second output torque member of the clutch assembly, the clutch having a second series of plates and a second series of cooling channels, each cooling channel defining a single port in fluid communication with at least one plate, wherein the port on each cooling channel is offset relative to ports on adjacent cooling channels.

13. The dual clutch assembly of claim 12 further comprising:
a first inner housing for the first clutch having a first series of splines, each spline providing one of the first series of cooling channels; and
a second inner housing for the second clutch having a second series of splines, each spline providing one of the second series of cooling channels.

14. The dual clutch assembly of claim 12 wherein the first inner housing and the second inner housing are configured to rotate with the input torque member of the clutch assembly.

15. The dual clutch of claim 12 wherein the first inner housing and second inner housing are configured such that flow to the first clutch is independent from flow to the second clutch.

16. A transmission comprising:
the dual clutch assembly of claim 12, the input torque member of the clutch assembly in communication with an input torque shaft of the transmission;
a first series of gears and clutches transmitting torque from the first output shaft of the dual clutch assembly to an output torque shaft of the transmission; and
a second series of gears and clutches transmitting torque from the second output shaft of the dual clutch assembly to the output torque shaft of the transmission.

17. The transmission of claim 16 wherein the first and second output torque members of the dual clutch assembly are coaxial with one another.

18. An inner housing for a clutch comprising:
a generally cylindrical housing formed about a longitudinal axis;
a first series of cooling channels supported by the housing and configured for flow along the longitudinal axis, each cooling channel defining a single aperture on an outer surface of the housing at a first position along the axis; and
a second series of cooling channels supported by the housing and configured for flow along the longitudinal axis, each cooling channel defining a single aperture on the outer surface of the housing at a second position along the axis.
wherein a cooling channel from the first series alternates with a cooling channel from the second series about the circumference of the housing.

19. The inner housing of claim 18 further comprising a third series of cooling channels supported by the housing and configured for flow along the longitudinal axis, each cooling channel defining a single aperture on the outer surface of the housing at a third position along the axis;
wherein a cooling channel from the first series, a cooling channel from the second series, and a cooling channel from the third series are positioned sequentially about the circumference of the housing.

20. The inner housing of claim 18 wherein each aperture from the first series and the second series is elongated and has a common cross-sectional area.
